(19) United States
(12) Patent Application Publication
(10) Pub. No.: US 2004/0231205 A1
(43) Pub. Date: Nov. 25, 2004

(54) Heat induced rotating ornament through driving vanes

(76) Inventor: James Jen, Longhua Town (CN)

Correspondence Address: CHARLES E. BAXLEY, ESQ., 90 JOHN STREET, THIRD FLOOR, NEW YORK, NY, 10038, US

(21) Appl. No.: 10/761,755

(22) Filed: Jan. 19, 2004

(30) Foreign Application Priority Data
May 21, 2003 (CN) 03 2 26462.3

(51) Int. Cl. G09F 13/00

(52) U.S. Cl. 40/431

(57) ABSTRACT

A heat induced rotating ornament that comprises a rotating bearer (1) with an ornament (8) fixed to its external surface, a vertical rod (2) and base (3) that support the rotating bearer (1) and a light source emitting heat (5); said ornament has its partial side surface made to be vanes evenly distributed with air-vane rake face and air exit as driving vanes (11); said rotating bearer (1) has a short vertical downward taper rod (14) at its inner top; the vertical rod (2) has a taper recess (231) at its top and the rotating bearer (1) has its short taper rod (14) put into the recess (231) at the top of the vertical rod (2); the light source emitting heat (5) warms the air in proximity and forms a rising air flow that acts on the driving vanes (11) in the ornament to produce lateral pushing force, thus driving the rotating bearer (1) and the ornament (8) fixed in the external surface rotate around the short taper rod (14), which is the supporting point, in the taper recess (231) at the top of the vertical rod (2). The current invention of heat induced rotating ornament is featured by its simple structure, beauty and safety in application.

### FIELD OF INVENTION

This invention is directed to a decorative rotating ornament driven by heat.

### BACKGROUND OF THE INVENTION

Most of the existing rotating decorative ornaments are driven by electricity or wind and are for the purpose of adding appeals to ornaments. However, either driving mode requires the ornaments having a relatively complex rotating mechanism, obviously increasing product structure complexity and manufacturing costs. Although some rotation ornaments do use heat as the driving force, such as the heat induced rotating lamp shade publicized in the patent US005491616A, which is conical lamp shade with many evenly distributed slits in the lamp shade surface. The lampshade surface at the slits is formed into vanes. Said lampshade has a recess at its internal top and a vertical rod with a taper tip is fixed onto the lamp base. The lampshade is freely put onto the vertical rod taper tip with said recess of the lampshade just seated onto said taper tip; when the electric bulb in the socket is lit, air around the bulb is warmed and rises to form a upward-going air flow, which, in turn, pushes the vanes in the lampshade surface to make the lampshade rotate around the rod with the taper tip as the bearing point. Said heat induced rotating lampshade has two disadvantages, namely on one hand the vanes in the surface of said lampshade negatively affect the appearance of the lampshade, on the other hand, when the lampshade is moved from the rod with taper tip by man or accidentally, the vertical and upward taper tip will easily cause human injuries.

### BRIEF SUMMARY OF THE INVENTION

The present invention is to provide a beautiful and safe heat induced rotating ornament.

The current invention adopts the following technical design: a heat induced rotating ornament that comprises a rotating bearer with ornament fixed to it, a vertical rod that supports the bearer and a base. Said vertical rod is fixed to the base and on said base is a light source under said rotating bearer that emits heat; the current invention is characterized by: the ornament that is fixed to the external surface of said rotating bearer is made into driving vanes with air-vane rake face and air exit; said rotating bearer has a short vertical downward tapered rod at its inner top; said vertical rod has a taper recess with upward opening at its top. Said rotating bearer with ornament fixed to its external surface is put onto the vertical rod vertically to make the taper of said short vertical rod just fall into the taper recess at the top of said vertical rod; said light source emitting heat makes the air around it warm and cause local low air pressure in the proximity of the light source, which makes the air around the light source go upward. The rising air flow acts on the vanes of the ornament and lateral pushing force is produced to drive the rotating bearer and the ornament fixed to its external surface to rotate around the short vertical rod with taper in the taper recess at the vertical rod. Owing to integration of the driving vanes into the ornament in design, so the vanes are not a negative factor in appearance of the ornament; furthermore, the taper tip that is easy to cause injuries is now concealed inside the rotating bearer, even if carelessness or accident makes the rotating bearer moved from the vertical rod, there is no danger of exposed taper tip, thus increasing safety.

Said rotating bearer is structured in axisymmetrical cone web that comprises at least two horizontal rings and at least two longitudinal frameworks that connect said horizontal rings. Said ornament is fixed to said horizontal rings or longitudinal frameworks. Said rotating bearer comprises also a top piece at the top, to which the taper tip is fixed at the lower part. Said top piece is made with decorative form to be a part of the ornament. The structure makes the ornament is very easy to be fixed to the rotating bearer without any negative influence on the appearance caused by exposure of the rotating bearer.

Said base has a half hole at its upper surface and the vertical rod is inserted into it and fixed; said light source emitting heat comprises many candles that are inserted into many sockets in the base around the vertical rod. Candles not only emit heat but also add romantics and gentleness.

Said ornament in the current invention direct to many versions. If only meticulous design is made, various ornaments can be fixed to the cone-shaped rotating bearer and make the driving vanes to be a part of the ornament without negatively affecting its beauty. The following are three embodiments:

Said ornament is a Christmas tree that comprises many tree leaves being the vanes fixed to the rotating bearer with air-vane rake faces; said Christmas tree leaves are simultaneous the driving vanes evenly fixed to said horizontal rings concealing the rotating bearer. Said top piece is a pentagram in shape. The rotating bearer is cone shaped and just matches the shape of a Christmas tree.

Said ornament is a roundabout lamp that comprises a bamboo hat shaped top shade fixed to the rotating bearer and running horses that are suspended under the shade by suspension rods. Said top shade has center symmetric slits in its central side surface and part of the side surface of the top shade is pressed into air-vanes through these slits. Said top piece is torch shaped.

Said ornament is an angle that comprises a skirt with many driving vane units with air-vane rake face and the angle's body fixed to the top of the skirt and the angle's head as the top piece.

Compared with the current technology, the current invention of heat induced rotating ornament has the following advantages: as the driving vanes are part of the ornament, it is more beautiful, as the taper tip, which is easy to hurt people, is not exposed, it is much safer.

### BRIEF DESCRIPTION OF THE DRAWINGS

FIG. 1 is a three-dimensional exploded view of the current invention of heat induced rotating ornament;

FIG. 2 is a three-dimensional view of embodiment 1 of current invention of heat induced rotating ornament (Christmas tree);

FIG. 3 is a three-dimensional view pf embodiment 2 of current invention of heat induced rotating ornament (roundabout lamp);

FIG. 4 is a three-dimensional view of embodiment 2 of current invention of heat induced rotating ornament (angle);

### PREFERRED EMBODIMENT

Further description of the current invention is given in the following in reference to the drawing.

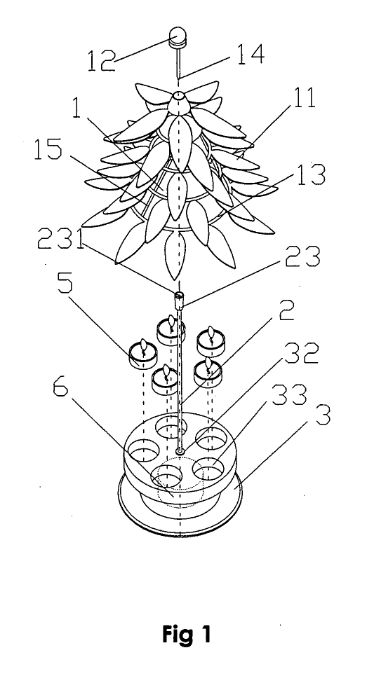

As shown in FIG. 1, the current invention of heat induced rotating ornament comprises a rotating bearer 1 with an ornament 8 fixed to its external surface, a vertical rod 2 and a base 3 supporting the rotating bearer 1. Said vertical rod 2 is vertically fixed to the base 3 and on said base 3 is a light source 5 emitting heat under said rotating bearer 1. Part of the ornament is made into evenly distributed driving vanes 11 with air-vane rake face and air exit; said rotating bearer 1 has a short vertical downward taper rod 14 at the inner top of said rotating bear 1; said vertical rod 2 has a taper recess 231 with upward opening at its top and said bearer 1 with ornament 8 fixed on its external surface is put vertically downward onto the vertical rod 2 with said short taper rod 14 matching with taper recess 231 at the top; said light source emitting heat 5 warms the air in proximity and form a local low air pressure to cause a rising air flow to act on the driving vanes 11 in the ornament, producing lateral forces to drive the rotating bearer 1 with the ornament 8 fixed on its external surface rotating around the short taper rod 14 in the taper recess 231 at the top of vertical rod 2. The short taper rod 14 and the taper recess are in point-contact, so the ornament has very small friction force when rotates; furthermore, even if there is a slight unbalance of the ornament fixed to the rotating bearer, it can work normally.

Said base 3 has a half hole 32 in the center and the vertical rod 2 is inserted into the half hole 32 to be fixed; said light source 5 comprises many candles that are inserted into the sockets 33 around the vertical rod 2 in the base 3.

The short taper rod 14 and taper recess 231 are made of wear resistant material. In order to facilitate manufacturing, said vertical rod 2 has a top cap 23 connected to it and said taper recess 231 is set on the top surface of it.

In order to make the ornament have sound, a sound gadget 6 can be set under the base 3.

Said rotating bearer 1 is axisymmetrical cone-shaped web that comprises at least two horizontal rings 15 of different diameters and at least two longitudinal frameworks 13 connecting said rings 15. Said ornament 8 is fixed to said horizontal rings 15 or longitudinal frameworks 13. Said rotating bearer 1 has a top piece 12 fixed to it, and the short taper rod 14 is fixed to the lower part of top piece 12. Said top piece 12 has an appearance of ornamentation to be a part of the ornament 8. The above-mentioned structure of rotating bearer is adaptable to many applications and if only meticulous design is made, all shapes of ornaments can be fixed to the above-mentioned cone-shaped rotating bearer 1 and part of the ornament is made to be the driving vanes without any negative influence on beautiful appearance. The following are three embodiments:

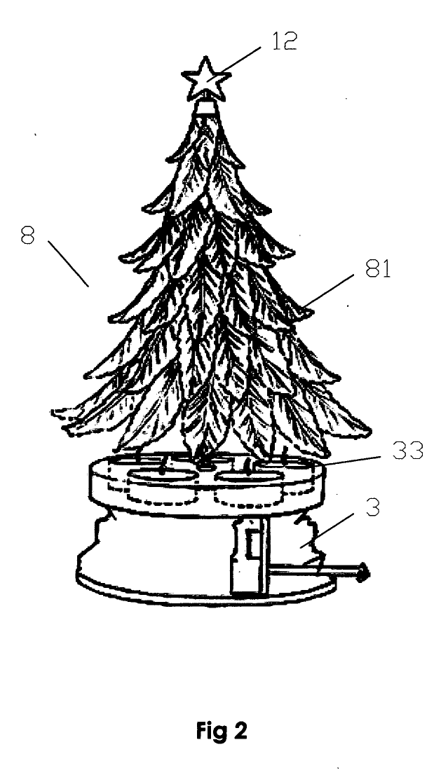

Embodiment 1: Said ornament 8 is a Christmas tree as shown in FIG. 2. The Christmas tree comprises many Christmas tree leaves 81 with air-vane rake face fixed to the rotating bearer 1; said Christmas tree leaves 81 are simultaneously the driving vanes evenly distributed fixed to the horizontal rings 15 concealing the rotating bearer 1. Said top piece 12 is pentagram shaped. The cone-shaped rotating bearer 1 just matches the shape of the Christmas tree.

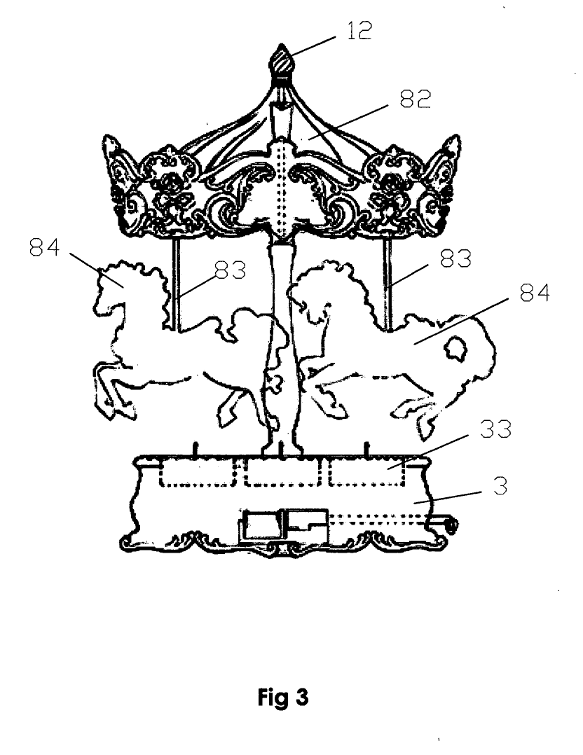

Embodiment 2: Said ornament 8 is a roundabout lamp as shown in FIG. 3. The roundabout lamp ornament comprises a bamboo hat shaped shade 82 and running horses 84 suspended under the shade by suspension rods 83. Said shade 82 has center symmetrical slits on its central side surface, though witch part of the side surface is formed into driving vanes 11 with air-vane rake face. Said top piece 12 is torch shaped.

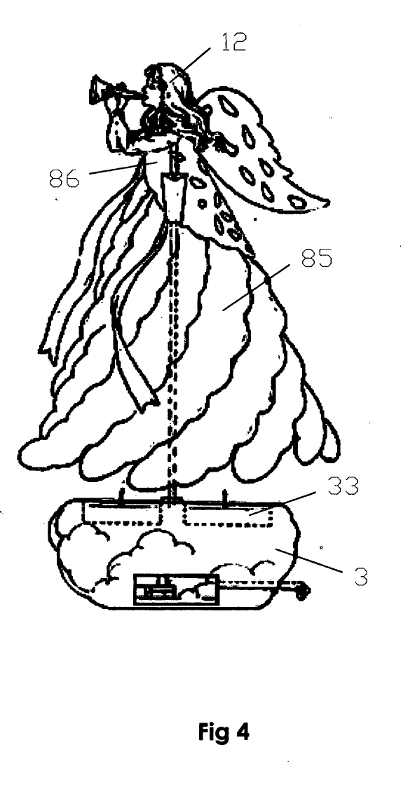

Embodiment 3: Said ornament is an angel as shown in FIG. 4. The angel ornament comprises a skirt 85 that has many vane units with air-vane rake face and fixed to the rotating bearer 1 and the angel's body 86 fixed to the top of skirt and the angel's head as the top piece 12.

What is claimed is:

1. A heat induced rotating ornament that comprises a rotating bearer (1) with an ornament (8) fixed to its external surface, a vertical rod (2) and base (3) that support the rotating bearer (1). Said vertical rod (2) is vertically fixed to the base (3) and a light source emitting heat (5) is set on the base (3) under the rotating bearer (1); it is characterized by: the ornament fixed to the external surface of said rotating bearer (1) has partial side surface formed into evenly distributed vanes (11) with air-vane rake face and exit; said rotating bearer (1) has a short vertical downward taper rod (14) at its inner top; said vertical rod (2) has a taper recess (231) with upward opening. Said rotating bearer (1) with ornament (8) fixed to its external surface is put downward vertically with the taper of said short taper rod (14) fall into the taper recess (231) at the top of the vertical rod (2); said light source emitting heat (5) warms the air in proximity and forms a local low pressure at the light source (5), thus forming a rising air flow that acts on the driving vanes (11) of the ornament to produce lateral force, resulting in driving the rotating bearer (1) and the ornament fixed to its external surface rotate around the short taper rod (14), as the supporting point, in the taper recess (231) at the top of the vertical rod (2).

2. A heat induced rotating ornament as defined in claim 1 is characterized by: said rotating bearer (1) is an axisysmetric cone-shaped web that comprises at least two horizontal rings (15) of different diameters and at least two longitudinal frameworks (13), and said ornament (8) is fixed to said horizontal rings (15) or longitudinal frameworks (13); said rotating bearer (1) also comprises a top piece (12) at the top, a short taper rod (14) fixed to the lower part of the top piece (12), said top piece (12) is decorative in shape constituting a part of the ornament (8).

3. A heat induced rotating ornament as defined in claim 1 is characterized by: said base (3) has a half hole (32) in its center and the vertical rod (2) is inserted into this half hole (32) and fixed; said light source emitting heat (5) comprises many candles that are inserted into many holes (33) in said base (3) around the vertical rod (2).

4. A heat induced rotating ornament as defined in claim 1 is characterized by: said vertical rod (2) has a top cap (3) located at its top, and said taper recess (231) is set at the upper surface of the cap.

5. A heat induced rotating ornament as defined in claim 1 is characterized by: a sound gadget (6) is set at the bottom of said base (3).

6. A heat induced rotating ornament as defined in claim 2 is characterized by: said ornament (8) is a Christmas tree that comprises many Christmas tree leaves (81) with air-vane rake face fixed to the rotating bearer (1); said Christmas tree leaves (81) are simultaneously driving vanes evenly distributed fixed to said horizontal rings (15), concealing the rotating bearer (1). Said top piece (12) is pentagram shaped.

7. A heat induced rotating ornament as defined in claim 2 is characterized by: said ornament (8) is a roundabout lamp that comprises a bamboo-hat shaped top shade (82) fixed to the rotating bearer (1) and running horses (84) suspended under the top shade through suspension rods (83), and said top shade (82) has center symmetric slits in part of its central side surface, though which partial surface of the shade is formed into driving vanes (11) with air-vane rake face. Said top shade is torch shaped.

8. A heat induced rotating ornament as defined in claim 2 is characterized by: said ornament (8) is an angel that comprises a skirt (85) having many units of driving vanes with air-vane rake face and the angel's body (86) fixed to the top of skirt and a top piece (12) as the angel's head.
